(19) United States
(12) Patent Application Publication
(10) Pub. No.: US 2008/0194744 A1
(43) Pub. Date: Aug. 14, 2008

(54) Polyester Resin Composition for Covering Material of Cable and Cable Using the Same

(76) Inventors: Jeong-Bin Ok, Seoul (KR); Myeong-Jin Ahn, Seoul (KR)

Correspondence Address: STROOCK & STROOCK & LAVAN LLP, 180 MAIDEN LANE, NEW YORK, NY, 10038, US

(21) Appl. No.: 11/915,295

(22) PCT Filed: Jul. 1, 2005
(86) PCT No.: PCT/KR2005/002099

§ 371 Date: Nov. 21, 2007

(30) Foreign Application Priority Data
May 24, 2005 (KR) 10-2005-0043871

(51) Int. Cl. C08K 5/16

(52) U.S. Cl. 524/186

(57) ABSTRACT

Disclosed is a polyester resin composition for a covering material of a cable. The present invention provides the polyester resin composition for a covering material of a cable including a polyester resin as a base resin, including 0.1 to 4 parts by weight of amide-based wax as an internal lubricant, based on 100 parts by weight of the polyester resin as the base resin. The polyester resin composition according to the present invention has advantages that the resin may be uniformly and completely melted using only the general equipments such as an extruder with an L/D ratio of less than 30 and a single-stranded screw without an additional investment for equipments, and also has such an improved processability that protrusions are minimized upon forming a covering layer of a cable, as well as an excellent mechanical properties such as tensile strength, elongation, etc.

### TECHNICAL FIELD

The present invention relates to a composition for a covering material of a cable including a polyester resin as a base resin, and a cable using the same.

### BACKGROUND ART

FIG. 1 is a cross-sectional view showing a conventional cable. Referring to FIG. 1, the cable 10 is generally composed of a conductor bundle 1, and at least one covering layer 3 surrounding the conductor bundle.

In recent years, there have been attempts to use polyester resins such as polyethyleneterephthalate (PET), polybutyleneterephthalate (PBT) and the like as a base resin of a covering material of a cable, the PET and PBT being more inexpensive than other engineering plastics as well as having excellent physical properties in strength, heat resistance, etc.

However, the polyester resin generally has problems that it needs a high latent heat upon melting because it has a high crystallinity, and also exhibits such a poor processability that it is not uniformly and completely melted upon extrusion. Since the resin is not uniformly melted upon manufacturing a film, a cable or the like, uneven protrusions (gels, fish eyes) also appear in an appearance of the product, and therefore physical properties and a quality of the product are deteriorated.

In order to solve the problems, there have been many attempts to melt the polyester resin completely and uniformly, for example using a long extruder having an LID ratio of 30 or more, or a barrier screw having an improved melting property.

The extruder having an L/D ratio of 30 or more is an equipment used for melting the resin effectively by maximizing a frictional heat generated between the resin and the screw as well as heating the resin for an extended time. Unlike general screws, the barrier screw is also designed to have a double-helical structure, wherein only the melted resin is collected in a narrow portion of the barrier screw and only the unmelted resin is collected in an opposite wide portion of the barrier screw. Accordingly, a melting efficiency may be maximized and a uniform melting be facilitated by separating the melted portion and the unmelted portion from each other.

However, these methods have problems that they are uneconomical since an additional cost is required for equipments such as new exclusive extruders, screws, etc. without using existing equipments, and physical properties of covering materials may also be deteriorated since the polyester resin may be hydrolyzed due to a long residence time in the process.

### DISCLOSURE OF INVENTION

### Technical Problem

Accordingly, the present invention is designed to solve the problems of the prior art, and therefore it is an object of the present invention to provide a polyester resin composition for a covering material of a cable capable of minimizing formation of protrusions upon forming a covering layer of a cable since a resin is uniformly and completely melted without an additional equipment as well as maintaining suitable mechanical properties such as tensile strength and elongation, and a cable using the same.

### Technical Solution

In order to accomplish the above object, the present invention provides a polyester resin composition for a covering material of a cable including a polyester resin as a base resin, including 0.1 to 4 parts by weight of amide-based wax as an internal lubricant, based on 100 parts by weight of the polyester resin as the base resin.

At this time, the used polyester resin is preferably at least one selected from the group consisting of polyethyleneterephthalate (PET), polybutyleneterephthalate (PBT) and thermoplastic elastomer-ester (TPE-E) copolymers thereof. Also, the amide-based wax is preferably at least one selected from the group consisting of TR-016, TR-065 (Strucktol), Armoslip (Akzo) and LC140 (Lion Chemtec), and they may be used alone or in combinations thereof.

Also, the resin composition of the present invention preferably further includes 0.1 to 4 parts by weight of a fluorine-based processing aid, wherein the fluorine-based processing aid is preferably at least one selected from the group consisting of Dynamar (3M), Viton FreeFlow (Dupont-Dow) and mixtures thereof, and they may be used alone or in combinations thereof.

Meanwhile, the present invention provides a cable including a conductor bundle;

and a covering layer surrounding the conductor bundle, wherein the covering layer is formed of the mentioned-above polyester resin composition.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a cross-sectional view showing a configuration of a conventional cable.

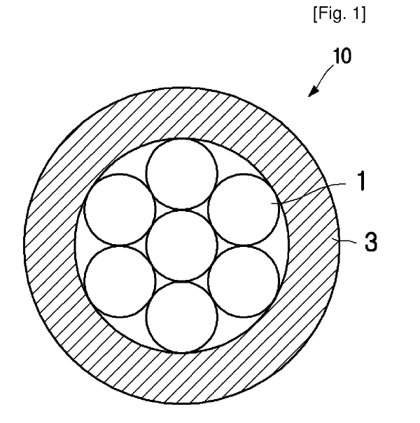

### BEST MODE FOR CARRYING OUT THE INVENTION

Hereinafter, preferred embodiments of the present invention will be described in detail.

The inventors had many attempts to improve physical properties such as a melting property so as to solve a problem caused when a polyester resin is used as the covering material of a cable. As a result, the inventors found that, if an optimal amount of mixed amide-based wax is used as an internal lubricant, a polyester resin may be uniformly and completely melted using only the conventional equipments without an additional equipment, and such processability that uneven protrusions are minimally formed in an appearance of the resultant product may be improved, and suitable mechanical properties may be also maintained. The present invention has been completed based on the above facts.

A polyester resin is used as the base resin of the composition according to the present invention. Such a polyester resin is not particularly limited if it may be generally used as the covering material of a cable, and for example polyethyleneterephthalate (PET), polybutyleneterephthalate (PBT) and thermoplastic elastomer-ester (TPE-E) colpolymers thereof may be preferably used alone or in combinations thereof. Such a polyester resin has an excellent mechanical strength at a wide temperature range; excellent physical properties such as chemical resistance, weather resistance, long-term heat resistance, etc.; and excellent electrical properties such as an insulation property.

In order to improve processability, the insulating polyester composition according to the present invention includes 0.1 to 4 parts by weight of amide-based wax as an internal lubricant, based on 100 parts by weight of the base resin.

Generally, the internal lubricant takes a role of lowering viscosity of a melt since the internal lubricant is easily melted in the resin, and it acts with being impregnated into a polymeric resin which is the base resin. It is important that such a lubricant is compatible with the polymeric resin, and therefore an amount of a used polymeric resin and a concentration of a polymeric resin used for exhibiting a maximum effect may be varied according to kinds of the polymeric resins. For example, polyethylene wax, zinc stearate or the like have been widely used as the internal lubricant in the case of a polyolefin resin, but they may not be used as the internal lubricant since they have a poor compatibility with the polyester resin and a low decomposition temperature if the polyester resin is used as the base resin.

The amide-based wax used as the internal lubricant herein has an excellent compatibility with the polyester resin which is the base resin, and functions to improve a melting property of the resin composition of the present invention by maximizing a heat transfer efficiency in the polyester resin itself to overcome an incomplete and ununiform melting problem caused by a high latent heat of the polyester resin.

A content of the amide-based wax in the polyester resin composition of the present invention ranges from 0.1 to 4 parts by weight, preferably from 0.5 to 3 parts by weight, and more preferably from 0.8 to 2.5 parts by weight, based on 100 parts by weight of the base resin. The content is selected in consideration that the protrusions are not reduced if a content of the amide-based wax is less than 0.1 parts by weight, while the tensile strength at room temperature is significantly deteriorated if a content of the amide-based wax exceeds 4 parts by weight.

Such an amide-based wax is not particularly limited if it may be used for the covering material of a cable, and for example, TR-016 and TR-065 (Strucktol), Armoslip (Akzo), LC140 (Lion Chemtec) and so on may be used alone and in combinations thereof.

Preferably, the polyester resin composition according to the present invention further includes 0.1 to 4 parts by weight of a fluorine-based processing aid, based on 100 parts by weight of the base resin. Partial melting generated in a feeding zone of an extruder may deteriorate a heat transfer efficiency between the resin and screws, and barrels, which causes incomplete melting of the resin. However, the fluorine-based processing aid may improve processability by minimizing the partial melting.

In the present invention, a content of the fluorine-based processing aid ranges from 0.1 to 4 parts by weight, preferably from 0.2 to 3 parts by weight, and more preferably from 0.3 to 2 parts by weight, based on 100 parts by weight of the base resin. The content is selected in consideration that the protrusions are not reduced when the polyester resin composition is partially melted if a content of the fluorine-based processing aid is less than 0.1 parts by weight, while the tensile strength at a room temperature is significantly deteriorated if a content of the fluorine-based processing aid exceeds 4 parts by weight.

Such a fluorine-based processing aid is not particularly limited if it may be used for the covering material of a cable, and for example, Dynamar (3M), Viton FreeFlow (Dupont-Dow) and so on may be used alone and in combinations thereof.

In addition, the polyester resin composition according to the present invention may further include additives generally used for the covering material of a cable without departing from the spirit and scope of the invention. For example, the additive includes, but is not limited to, an antioxidant, an antihydrolysis agent, a flame retardant, a cross-linking agent, a cross-linking formulation, a flame retardant formulation, an antislip agent, an antistatic agent, etc.

For example, the antioxidant includes a heat stabilizer, a metal deactivator, a UV stabilizer, etc., as well as a phenol and phophite-based antioxidant. Such an antioxidant is preferably included at a content of 0.2 to 5 parts by weight, based on 100 parts by weight of the base resin.

For example, the antihydrolysis agent includes a diamide-based antihydrolysis agent, etc., and a content of the antihydrolysis agent preferably ranges from 0.2 to 5 parts by weight, based on 100 parts by weight of the base resin.

The polyester resin composition according to the present invention may be divided into two groups: a flame-retarding composition and a non-flame-retarding composition. For example, the flame retardant used for contributing to a flame retardancy includes, but is not limited to, a brominated flame retardant, antimony trioxide, phosphorus, melamine cyanurate, melamine phosphate, metal hydroxides, etc. The content of the flame retardant is preferably 70 parts by weight or less, based on 100 parts by weight of the base resin.

The polyester resin composition of the present invention may be used for forming a covering layer of a conventional cable. Generally, the covering layer of the cable may be configured as a single layer or multiple layers according to its usage, and the resin composition of the present invention may be applied to some or entire covering layer. Also, the polyester resin composition of the present invention may be in a cross-linked form, if necessary.

### MODE FOR THE INVENTION

Hereinafter, preferred embodiments of the present invention will be described in detail. However, the description proposed herein is just a preferable example for the purpose of illustrations only, not intended to limit the scope of the invention, so it should be understood that other equivalents and modifications could be made thereto without departing from the spirit and scope of the invention. Preferred embodiments of the present invention will be provided to those skilled in the art for the purpose of more full description of the present invention.

### Embodiments 1 to 4

Polyester resin compositions were prepared according to components and contents as listed in the following Table 1. Polybutyleneterephthalate or thermoplastic elastomer-ester was used as the base resin. A unit is represented by a part(s) by weight.

TABLE 1

| | Embodiments | | |
|---|---|---|---|
| Mixing agent | 1 | 2 | 3 |
| Polybutyleneterephthalate | 100 | 100 | |
| Thermoplastic elastomer-ester(TPE-E) | | | 100 |
| Amide-based wax | 1 | 0.5 | 0.5 |
| Fluorine-based processing aid | | 0.5 | 0.5 |
| Metal hydroxide | 20 | 20 | 20 |
| Brominated flame retardant | 30 | 30 | 30 |
| Antioxidant | 1.5 | 1.5 | 1.5 |
| Antihydrolysis agent | 1.5 | 1.5 | 1.5 |

In Table 1, TR-065 (Strucktol) was used as the amide-based wax, Dynamar FX5920A (3M) was used as the fluorine-based processing aid, Magnifin H5 (Albemarle) was used as the metal hydroxide, Saytex 102E (Albemarle) was used as the brominated flame retardant, Irganox1010 (Ciba) was used as the antioxidant, and Stabaxol P (Reine chemie) was used as the antihydrolysis agent.

### COMPARATIVE EXAMPLES 1 TO 4

Polyester compositions were prepared according to components and contents as listed in the following Table 2. Polybutyleneterephthalate or thermoplastic elastomer-ester was used as the base resin. A unit is represented by a part(s) by weight.

TABLE 2

| | Comparative examples | | | |
|---|---|---|---|---|
| Mixing agent | 1 | 2 | 3 | 4 |
| Polybutyleneterephthalate | 100 | 100 | | |
| Thermoplastic elastomer-ester(TPE-E) | | | 100 | 100 |
| Polyethylene wax | 2 | | | |
| Zinc stearate | | 2 | | |
| Amide-based wax | | | 5 | |
| Fluorine-based processing aid | | | | 5 |
| Metal hydroxide | 20 | 20 | 20 | 20 |
| Brominated flame retardant | 30 | 30 | 30 | 30 |
| Antioxidant | 1.5 | 1.5 | 1.5 | 1.5 |
| Antihydrolysis agen | 1.5 | 1.5 | 1.5 | 1.5 |

In Table 2, LC102N (Lione chemtec) was used as the polyethylene wax, TR-065 (Strucktol) was used as the amide-based wax, Dynamar FX5920A (3M) was used as the fluorine-based processing aid, Magnifin H5 (Albemarle) was used as the metal hydroxide, Saytex 102E (Albemarle) was used as the brominated flame retardant, Irganox1010 (Ciba) was used as the antioxidant, and Stabaxol P (Reine chemie) was used as the antihydrolysis agent.

The polyester resin compositions prepared according to the embodiments and the comparative examples were measured for mechanical properties and product appearances, as follows. For this purpose, the compositions were extruded with an extruder having a caliber of 25 mm and an LID ratio of 24 and a general screw having a compression ratio of 2.5:1 to obtain a tube having an inner diameter of 2 mm and a thickness of 0.1 mm.

<Evaluation of Mechanical Properties>

Mechanical properties were measured using a method of IEC 60811-1-1, and the measurement was carried out at a rate of 50 mm/min.

<Evaluation of Product Appearance>

A 1.0 km-long cable was cut into 100 m-long cables and six cables were randomly selected from the cables, and then their protrusions were counted to obtain a mean value.

The results of the mechanical properties and the product appearances are listed in the following Table 3.

TABLE 3

| | | Embodiment | | | Comparative examples | | | |
|---|---|---|---|---|---|---|---|---|
| Items | | 1 | 2 | 3 | 1 | 2 | 3 | 4 |
| Mechanical | Tensile strength (kgf/□) | 3.1 | 3.0 | 2.6 | 3.1 | 2.8 | 2.0 | 1.8 |
| property | Elongation (%) | 150 | 180 | 210 | 160 | 180 | 220 | 210 |
| Product | No. of | 1 | 0 | 0 | 4 | 6 | 0 | 1 |
| appearance | Protrusion (unit/100 m) | | | | | | | |

Referring to Table 3, it was revealed that the polyester resin compositions according to the embodiments had sufficient mechanical properties, as well as a very low number of the protrusions. It was also revealed that the polyester resin compositions including both of the internal lubricant such as the amide-based wax and the processing aid such as the fluorine-based processing aid (Embodiments 2 and 3) had more excellent physical properties than the composition according to Embodiment 1 including either the internal lubricant or the processing aid.

It was also revealed that, when zinc stearate or polyethylene wax was used as the internal lubricant as described in Comparative examples 1 and 2, more protrusions were generated even if the internal lubricant was used at an amount greater than those of the embodiments.

Meanwhile, it was revealed that the number of the protrusions was reduced but the mechanical properties such as the tensile strength were significantly deteriorated if excessive amounts of the amide-based wax and the fluorine-based processing aid were used in Comparative examples 3 and 4, respectively.

### INDUSTRIAL APPLICABILITY

Since the amide-based wax is used as an internal lubricant of the polyester resin composition, the polyester resin composition according to the present invention has advantages that the resin may be uniformly and completely melted only using the general equipments such as an extruder with an L/D ratio of less than 30 and a single-stranded screw without an additional investment for equipments, and also has such an improved processability that protrusions are minimized upon forming a covering layer of a cable, as well as an excellent mechanical properties such as tensile strength, elongation, etc.

1. A polyester resin composition for a covering material of a cable including a polyester resin as a base resin, comprising 0.1 to 4 parts by weight of amide-based wax as an internal lubricant, based on 100 parts by weight of the polyester resin as the base resin.

2. The polyester resin composition for a covering material of a cable according to claim 1,
wherein the polyester resin is at least one selected from the group consisting of polyethyleneterephthalate (PET), polybutyleneterephthalate (PBT) and thermoplastic elastomer-ester (TPE-E) copolymers thereof.

3. The polyester resin composition for a covering material of a cable according to claim 1,
wherein the amide-based wax is at least one selected from the group consisting of TR-016 and TR-065 (Strucktol), Armoslip (Akzo) and LC140 (Lion Chemtec).

4. The polyester resin composition for a covering material of a cable according to claim 1, further comprising 0.1 to 4 parts by weight of a fluorine-based processing aid, based on 100 parts by weight of the base resin.

5. The polyester resin composition for a covering material of a cable according to claim 4,
wherein the fluorine-based processing aid is at least one selected from the group consisting of Dynamar (3M), Viton FreeFlow (Dupont-Dow) and mixtures thereof.

6. A cable that includes a conductor bundle; and a covering layer surrounding the conductor bundle,
wherein the covering layer is formed of the composition as defined claim 1.

7. A cable that includes a conductor bundle; and a covering layer surrounding the conductor bundle,
wherein the covering layer is formed of the composition as defined in claim 2.

8. A cable that includes a conductor bundle; and a covering layer surrounding the conductor bundle,
wherein the covering layer is formed of the composition as defined in claim 3.

9. A cable that includes a conductor bundle; and a covering layer surrounding the conductor bundle,
wherein the covering layer is formed of the composition as defined in claim 4.

10. A cable that includes a conductor bundle; and a covering layer surrounding the conductor bundle,
wherein the covering layer is formed of the composition as defined in claim 5.
